(19) United States
(12) Patent Application Publication
(10) Pub. No.: US 2009/0126717 A1
(43) Pub. Date: May 21, 2009

(54) Solar Thermal Collection

(76) Inventor: Helmut Karl Nass, Pretoria (ZA)

Correspondence Address: HAHN AND MOODLEY, LLP, P.O. BOX 52050, MINNEAPOLIS, MN, 55402, US

(21) Appl. No.: 11/916,870

(22) PCT Filed: Jun. 13, 2006
(86) PCT No.: PCT/ZA06/00077

§ 371 Date: Dec. 7, 2007

(30) Foreign Application Priority Data
Jun. 13, 2005 (DE) DE102005027341.6

(51) Int. Cl. F24J 2/04; F24J 2/24; B23P 15/26

(52) U.S. Cl. 126/641; 126/666; 29/890.033

(57) ABSTRACT

Solar thermal collector body in the form of an integrally extruded or continuously cast panel including as an integral part of its cross-sectional profile a tubular hollow body adapted for the flow therethrough of a flowable heat carrier medium, including ends which permit the inflow of cold heat carrier medium and the withdrawal of the heated heat carrier medium respectively. The hollow body (1) is used as part of a solar collector Solar thermal collector including a collector box having a bottom area and side walls (13) and optionally a cover (16) allowing the entry of solar radiation into the box and forming a barrier against the escape of thermal radiation from inside the box wherein in a space above the bottom surface one or more thermal collector bodies (1) adapted for the through flow of a flowable, solar heat absorbing heat carrier medium is accommodated and is connected or connectable to feed and withdrawal ducts respectively for the heat carrier medium.

The present invention relates to a solar thermal collector body, a solar thermal collector including such collector body, and a use of such collector body for collecting solar heat, more particularly for solar hot water systems.

Conventional solar thermal collector bodies usually are in the form of a hollow body for the flow therethrough of a flowable heat carrier medium and have ends respectively permitting the inflow of the cold heat carrier medium and the withdrawal of the heated heat carrier medium.

Conventional solar thermal collector bodies are usually made of copper or sometimes plastic pipes usually mounted, e.g. soldered onto a copper sheet having a blackened surface. The surface area is sometimes corrugated to increase the surface area.

The manufacture of such collector bodies is often laborious and therefore expensive and has become more expensive with increases in the price of copper.

U.S. Pat. No. 4,111,188 discloses a solar thermal collector body in the form of an integrally extruded or continuously cast panel including as an integral part of its cross-sectional profile a tubular hollow body adapted for the flow therethrough of a flowable heat carrier medium which permits the inflow of cold heat carrier medium and the withdrawal of the heated heat carrier medium respectively. The collector body which is installed as a roof shingle, is made of extruded aluminum. However, the tubular hollow body occupies only a small contact width, approximately 7% of the overall width of the panel, as a result of which the heat transfer to the heat carrier medium is far from optimal. Moreover, in the manner in which the collector body is installed and used as a solar collector, a high percentage of the heat absorbed by the panel will be lost by radiation, particularly also from the bottom side of the panel having to travel a long distance before it can be conducted and transferred to the heat carrier medium

A known solar thermal collector includes a collector box, having a bottom wall and side walls, and optionally a cover which permits the passage of solar radiation, one or more hollow bodies for the flow therethrough of a flowable solar heat absorbing heat carrier medium being accommodated in a space above the bottom wall and connected or connectable to inlet and withdrawal ducts for the heat carrier medium.

It is an object of the invention to provide a solar thermal collector body and a solar thermal collector of the aforesaid type which is suitable for being mass-produced and capable of collecting solar heat with high efficiency. It is a further object to overcome or mitigate disadvantages of the prior art.

In accordance with the invention, the hollow body is an integrated extrusion or continuously cast profile in one piece having the cross-section of a flattish tubular profile having a broad top wall and a broad bottom wall, whereof at least the top wall being the side for facing the sun, is provided with integrated surface enlarging laminar outwardly directed heat absorption and transfer ribs parallel to the tube axial direction respectively the direction of extrusion or continuous casting.

It is preferably dark coloured, more particularly black; preferably by anodizing or coating, at least on the side carrying the ribs, preferably all round. Anodizing is particularly preferred. Anodizing may also be applied to the inside for corrosion protection.

Preferably, the hollow body, preferably at least on the top wall carrying ribs on the outside, also carries on its inside inwardly directed ribs parallel to the tubular axial direction, which is also the extrusion or continuous casting direction.

Because the ribs (outside as well as inside) are formed integrally with the tube walls by the extrusion or continuous casting process, these are not only formed very easily, without labour cost, but also in seamless connection to the body as a whole. This ensures optimal heat transfer conditions from the exterior, where absorption takes place, to the heat carrier medium inside the hollow body.

Preferably, the cavity portion of the flat tubular profiles has an at least by approximation elongate rectangular cross section, preferably with a ratio of width to thickness of between about 30:1 and 4:1, more preferably, between 20:1 and 7:1, in particular about 12:1.

The exterior ribs are, for example, from about 3 to about 30 mm high, preferably 5 to 20 mm, in particular about 8 to 12 mm. They may be spaced, centre to centre about 3 to 30, preferably 5 to 20, say 10 mm apart.

The internal ribs may be similarly spaced and may extend a distance of from about 20% to 100%, more preferably 30% to 70%, in particular about 50% of the interior height of the cavity into the said interior.

The profile has preferably, in particular inside the cavity, integrated rebated formations, extending longitudinally to the tubular axis and extrusion or continuous casting direction for accommodating screws, preferably self-tapping screws, preferably of stainless steel, for tensioning the open ends of the hollow body against connecting ducts for the heat carrier medium in communication with one another. These rebated formations preferably take the form of channels, parallel to the ribs, preferably of circular internal cross-section, preferably open to one side along the longitudinal direction of the rebate.

In contrast to U.S. Pat. No. 4,111,188 the heat absorbed by the panel surface need not be conducted very far to reach the heat transfer medium. In addition, the area of interface with the heat transfer medium is greatly enlarged by comparison, both by the flattish configuration of the inside of the hollow body as well as by the inside heat transfer ribs and by the rebated formations.

According to preferred embodiments an inlet duct and a withdrawal duct is respectively connected by way of apertures through a preferably plane side wall of the respective duct to one end each of the hollow body in sealing relationship therewith. This connection may be brought about in any suitable manner, e.g. by bonding welding, soldering. Preferably, the connection is brought about by screws passing through the ducts and screwed into the aforesaid rebated formations, appropriate sealing means, preferably gaskets being used to bring about the required sealing relationship.

Preferably, the duct is a continuously cast or extruded profile which is plane along at least one side of its outside, preferably having a rectangular or square exterior cross-section and preferably having a circular interior cross-section. The inlet and withdrawal ducts are preferably manufactured from the same material or kind of material as the hollow bodies, preferably likewise by continuous casting or extrusion.

Preferably, at last the solar collector body proper is made of metal, preferably light metal, preferably of aluminum or aluminum alloy. However, it will be understood by a person skilled in the art that, in principle, any material of suitable thermal conductivity may be used, provided it lends itself to continuous casting or extrusion in the form of a profile as described.

The solar thermal collector according to the invention, according to the generic clause of the introduction is characterized in that the solar thermal collector body/bodies contained therein, has/have the features of the invention as described above.

In accordance with particularly preferred embodiments the collector box has side walls having a reversible profile including a lateral, outwardly directed mounting flange which, depending on whether the collector is to be mounted on a roof surface or the like or is to be recessed into such surface, is provided proximate either to the lower edge or to the upper edge of the side wall, two inwardly directed flanges close to the lower and upper edges respectively for mounting thereon a bottom panel and a cover panel, the latter for admitting solar radiation therethrough and for forming a barrier against the escape of thermal radiation from inside the box, and, preferably halfway between the two inwardly directed flanges, a further inwardly directed flange for holding in place an insulation body between the bottom panel and such further flange.

The profiles of the side walls are preferably manufactured by extrusion or continuous casting, e.g. from any of the materials described above for making the hollow bodies. Aluminum or aluminum alloy is particularly preferred and may be anodized for corrosion protection.

The cover panel may be a clear glass sheet, e.g. shatterproof glass or a clear plastic material capable of withstanding weathering, and solar, in particular UV radiation. Whatever material is selected, it should be capable of transmitting and letting in as much as possible of the full spectrum of solar radiation but be suitable for retaining in the box as much as possible of any thermal radiation (i.e. long wave infra red) radiated by the collector bodies. Particularly preferred is glass carrying micro prisms on its inwardly directed surface for enhancing reflection of radiation from inside the box back into the box and onto the hollow body/bodies. Optionally, multiple, e.g. double glassing of the top of the collector box may be employed.

In the preferred embodiment thermal insulation is provided below the hollow body/bodies and above the bottom panel, preferably rendered reflective on its upper side, for example a thermal insulating body the upper side of which carries a reflective foil.

Such thermally insulating body may be made of any suitable thermally insulating material, capable of withstanding the temperatures arising in the box, preferably fibreglass or glass wool or rock wool or slag wool or expanded solids such as bloated ceramics or gas concrete. Also suitable is exfoliated vermiculite, in loose particulate form or bonded as a panel.

The side walls of the box are preferably thermally insulated in a similar manner, preferably likewise including a reflective surface, e.g. carrying a reflective foil facing the box interior.

Preferably, the hollow body/bodies is/are mounted freely suspended in the collector box, in particular spaced from the thermal insulation and/or reflective surface above the bottom panel, for example being held so suspended by the feed and withdrawal ducts, which in turn preferably pass through the side walls of the collector box. In this manner solar radiation reflected from the reflective surface can be absorbed through the underside of the hollow body or bodies.

The heat carrier medium may be any fluid capable of absorbing heat. It may be a gas, liquid or suspension. It may be a substance which itself is to be used in a heated condition, e.g. air for space heating or water to be used as such as hot water. It may also serve as a heat transfer medium for transferring solar thermal energy from the collector to another locality where the heat is to be transferred, e.g. to water to be heated or to a heat storage medium. In the case of solar hot water systems, such indirect heating is employed whenever a freezing risk exists which could cause damage to the collector. In that case, the heat carrier medium is usually a brine or water containing any suitable anti-freezing agent, a water soluble substance, e.g. glycol or polyglycol. High boiling oils are other substances, e.g. anthacene oil may be used for operating at temperatures exceeding the boiling point of water.

In what follows the invention will be further described by way of example with reference to the accompanying drawings which represent in

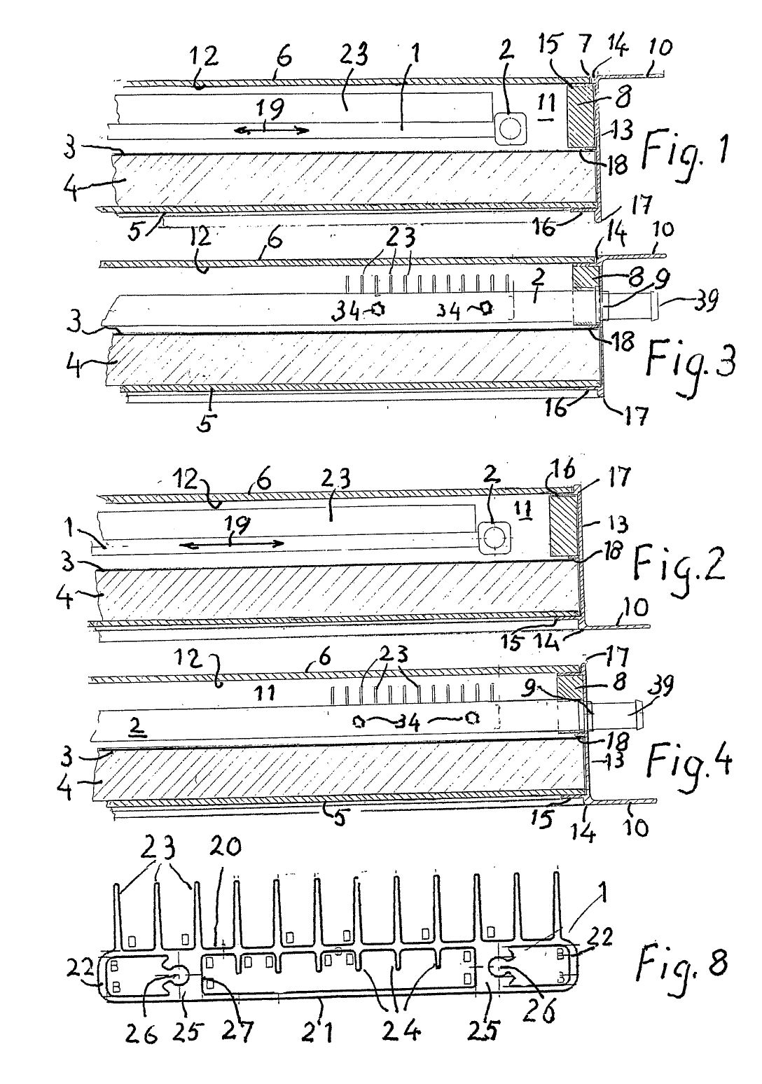

FIG. 1 a transverse section through a solar thermal collector box according to the invention for in-roof mounting, a collector body inside thereof being shown in elevation;

FIG. 2 a section similar to FIG. 1 but of an embodiment for on-the-roof mounting;

FIG. 3 a longitudinal section of the embodiment in FIG. 1;

FIG. 4 a longitudinal section of the embodiment in FIG. 2;

FIG. 5 a transverse section through an inlet or withdrawal duct for heat carrier medium into and out of a collector body;

FIG. 6 a side elevation of an insulating bush for thermally insulating a duct according to FIG. 5 against the side walls of the collector box, where the duct is fitted to and passes through the side wall of the box;

FIG. 7 an end-on elevation of the bush in FIG. 6;

FIG. 8 a transverse section through the profile of a solar thermal collector body according to the invention;

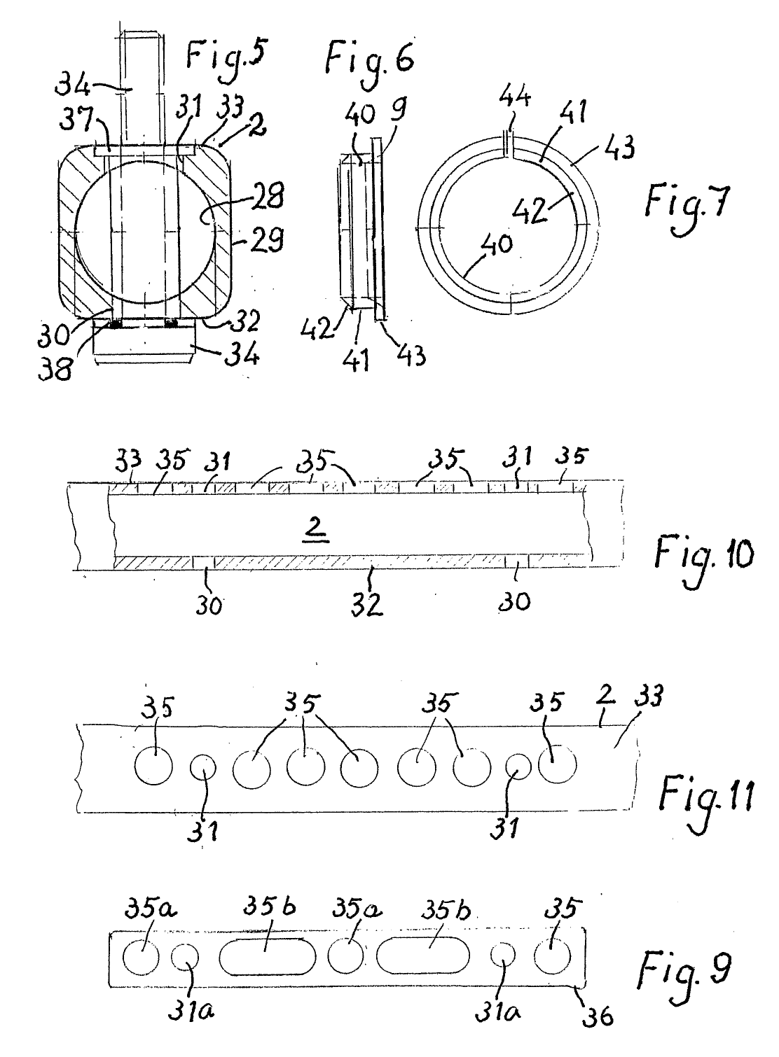

FIG. 9 a plan view of a gasket for sealing the connection between the ducts and the collector bodies;

FIG. 10 a longitudinal section through part of the duct in FIG. 5; and

FIG. 11 a side elevation of the duct shown in FIG. 10.

Referring to FIGS. 1 to 4, there is shown a solar thermal collector, including solar thermal collector bodies 1 fitted in sealing relationship at its ends to inlet respectively withdrawal ducts 2, and suspended between the ducts 2 in a space 11 formed between a reflector foil 3 carried by the upper surface of a thermal insulation body 4, supported on a bottom panel 5 and a cover panel 6 of shatterproof glass. The clear, transparent cover panel 6 carries on its underside 12 micro prisms which, by reflection, inhibit the escape of radiation from the space 11.

The solar thermal collector is in the form of a tray-shaped box formed by the side wall profiles 13 and a bottom panel 5 of any suitable material, preferably fibre cement or wood fibre hardboard. For that purpose the side wall profile 13, which is reversible, comprises a lateral outwardly directed mounting flange 10 along an edge 14, which in FIGS. 1 and 3 serves as a top edge and in FIGS. 2 and 4 as a bottom edge. If, as shown in FIGS. 1 and 3, the mounting flange is at the top, the collector box is to be mounted in recessed relationship to a roof or other supporting surface. If the mounting flange is at the bottom, it serves to fix the collector box on top of a roof or other supporting surface.

In addition, the side wall profile 10 has an inwardly directed flange 15 near edge 14 and a second similar inwardly directed flange 16 near the opposite edge 17 whichever of flanges 15, 16 is near the top, is used as a support for the glass cover panel 6 which is bonded at 7 in sealing relationship to the flange, e.g. in a manner known for automobile glass in the motor industry. The other flange 15,16, which is near the bottom, is used for supporting and fixing thereto the bottom panel 5 in any suitable manner, e.g. adhesively and/or by means of fasteners, e.g. rivets or screws.

The edges 14, 15 preferably stand slightly proud of the adjoining inwardly directed flanges 15, 16, thereby forming a rebate for positioning the panels 5 and/or 6.

Halfway between the flanges 15 and 16 a third inwardly directed flange 18 is provided as part of the side wall profile. The flange 18 serves to retain the top surface of the insulating body 4 and the reflective foil 3 carried on that top surface.

FIG. 8 shows the complete cross-section of the extruded hollow profile of collector bodies 1 in FIGS. 1 to 4. The direction of the longitudinal axis of the hollow body which is also the direction in which the aluminum has been extruded to form the body 1, is indicated as 19 in FIGS. 1 and 2. The profile comprises a flat elongate tube of approximately rectangular cross-section having a flat top wall 20 and a flat bottom wall 21 connected by side walls 22. The ratio of the thickness (represented by the side walls 22) of the rectangular cross-section to the width of the latter (represented by the top and bottom walls 20, 21) is about 1:12 in FIG. 8. The top wall carries on its outside in integral relationship a plurality of upright surface area enlarging laminar heat transfer ribs 23, approximately 10 mm apart, centre to centre and about 10 mm high, extending in the direction of the glass cover panel 6.

Opposite most of the exterior ribs, internal ribs 24 extend about halfway (50%) of the interior height of the cavity into the interior of the hollow body 1. In addition, the hollow body 1 carries inside the cavity and extending all the way between the flat walls 20 and 21 rebated formations 25 extending longitudinally parallel to the ribs, i.e. parallel to the direction of extrusion and being in the form of channels of circular internal cross-section, open to one side by virtue of a longitudinal slot 26. These rebates serve to accommodate screws passing through the ducts 2 and drawing these ducts via a flat side thereof, traversed by passage means in sealing relationship against the open ends of the hollow bodies 1. In the drawing the rebated formations 25 extend over the entire space between the two flat walls 20 and 21, and are integrally connected to both walls. It will be understood by the person skilled in the art that while this may be preferred, alternative arrangements are possible and that, while two rebate formations are shown, the hollow body may have any suitable number of such rebate formations needed to establish a tight connection between the hollow body I and the ducts 2. Whereas in the drawing one side 27 of the rebate formation 25 is shown as being planar, different configurations are possible, e.g. a concave or convex curvature, preferably the same convex circular curvature as on the opposite side.

Referring now to FIGS. 5 and 9 to 11, the duct 2, which, like the hollow bodies 1, is extruded from aluminum or aluminum alloy and coated or anodized mat black has a circular interior cross-section 28 and a square exterior cross-section 29. Bores 30, 31 are provided passing through opposite side walls 32 and 33 respectively, of which at least side wall 33 is planar on the outside. The bores 30, 31 accommodate self-tapping stainless steel screws 34. Side wall 33 also includes additional apertures, e.g. bores 35 for establishing the required communication between the inside of the duct 2 and the inside of the hollow bodies 1 fitted thereto. For establishing a sealing relationship between the collector body 1 and the duct 2, a gasket 36 as illustrated in FIG. 9 is inserted between the planar wall 33 and the adjoining open end of the hollow collector body 1. In FIG. 5 a machined rebate 37 is provided for accommodating the gasket 36. However, alternatively the gasket may be fitted directly on the planar outer surface of wall 33. The gasket 36 has apertures 31a, 35a and 35b matching the apertures 31 and 35 of duct 2. Between the head of the screw 34 and the wall 32 a gasket 38 is provided.

As shown in FIGS. 3 and 4, the ends 39 of ducts 2, where they pass through holes in the side wall profile 13, have been machined to a circular exterior cross-section to form hosepipe nipples. Between the hole through the side wall profile 13 and the machined end 39 of duct 2 the polyamide insulating bush 9, having a bore 40 tightly fitting around the machined end 39 of duct 2, is inserted with a resilient press-fit. It has a cylindrical portion 41 with a chamfered end 42 and an exterior flange 43. For ease of assembly the bush is split open at 44.

In the preferred embodiments a plurality of the hollow bodies are mounted side by side, connected in parallel, in the tray-shaped box. Preferably, any gaps between individual hollow bodies and between the hollow bodies and the side walls of the box in plan view occupy from 1 to 50%, more preferably from 5 to 40%, most preferably from 5 to 20% of the internal total surface area of the box. In the above examples the percentage so covered is the same as the plan view area of the interior of the hollow bodies less their wall thickness. This differs substantially from U.S. Pat. No. 4,111,188, where the area of the tubular hollow body in contact with the total surface area of the panel exposed to solar radiation is about 7%.

1-25. (canceled)

26. Solar thermal collector including a collector box having a bottom wall and side walls (13) and a top, allowing the entry of solar radiation into the box, optionally with a cover (6), forming a barrier against the escape of thermal radiation from inside the box, wherein in a space above the bottom wall one or more thermal collector bodies (1), adapted for the throughflow of flowable, solar heat absorbing heat carrier medium, is/are accommodated, being respectively connected or connectable to feed and withdrawal ducts for the heat carrier medium, wherein
the one or more thermal collector body/ies is/are thermally absorptive, integrally extruded or continuously cast hollow body/ies including as an integral part of its/their cross-sectional profile a tubular hollow body adapted for the flow therethrough of a flowable heat carrier medium, and being an integrated extrusion or continuously cast profile in one piece having the cross-section of a flattish tube profile formed by a broad top wall (20) integrally connected on opposite sides to a broad bottom wall (21), whereof at least the top wall (20) carries integrated surface enlarging outwardly directed heat transfer ribs (23) parallel to the tube axial direction (19) being the direction of extrusion or continuous casting and being set up for the said top wall (20) to be the side facing the sun so that the outwardly directed ribs (23) act as heat absorption and transfer ribs for absorbing solar radiation and transferring it as heat to the flowable heat carrier medium flowing through the tubular hollow body, connected for the inflow of cold heat carrier medium and for the withdrawal of the heated heat carrier medium.

27. The solar thermal collector claimed in claim 26, wherein the extruded or continuously cast hollow thermal collector body/ies is/are made of aluminum or aluminum alloy, anodized black.

28. Solar thermal collector according to claim 26, wherein the collector box includes a cover panel (6), allowing the entry of solar radiation into the box and forming a barrier against the escape of thermal radiation from inside the box, which cover panel, on its inner side, is provided with reflective micro-prisms.

29. Solar thermal collector according to claim 26, wherein the hollow thermal collector body or bodies carries/carry inwardly directed integrally cast or extruded ribs (24) on the inside, parallel to the tube axis direction (19).

30. Solar thermal collector according to claim 29, wherein the inwardly directed ribs (24) on the inside, parallel to the tube axis direction (19) are carried on the top wall which also carries the outwardly directed ribs (23).

31. Solar thermal collector according to claim 26, wherein the collector box includes side walls (13) having a reversible profile including a lateral outwardly directed flange (10) which, depending on whether the collector is intended for mounting on a roof surface or the like or recessed into such surface, is provided proximate to either the lower edge (14, 17) or the upper edge (14, 17) of the side wall (13), two inwardly directed flanges (15, 16) proximate to the lower and the upper edges (14, 17) for respectively having fitted thereto a bottom panel (5) and a cover panel (6), the latter for admitting solar radiation therethrough and for forming a barrier against the escape of thermal radiation from inside the box and further comprising, between the two inwardly directed flanges, a further inwardly directed flange (18) for positioning an insulation body provided between the bottom panel and such further flange.

32. Solar thermal collector according to claim 26, wherein the collector box has thermally insulated bottom and side walls rendered inwardly reflective or lined with reflective material, and that in the collector box the one or more hollow thermal collector bodies (1) is/are mounted in a freely suspended manner, at a distance from the reflective bottom wall and so that the internal total percentage surface area of the box not covered by the hollow thermal collector body or bodies is from 1 to 50%.

33. Solar thermal collector according to claim 32, wherein said total percentage surface area of the box not covered by the hollow thermal collector body or bodies is from 5 to 40%.

34. Solar thermal collector according to claim 32, wherein said total percentage surface area of the box not covered by the hollow thermal collector body or bodies is from 5 to 20%.

35. Solar thermal collector according to claim 32, wherein a plurality of the hollow thermal collector bodies are thus mounted with gaps there between.

36. Solar thermal collector according to claim 32, wherein the broad flat bottom wall (21) of the tubular hollow thermal collector body/ies has/have a flat outer bottom surface facing at a distance the reflective bottom wall of the collector box.

37. Solar thermal collector according to claim 26, wherein the hollow thermal collector body/ies carries/y inside rebated formations (25) extending longitudinally parallel to the ribs, extending over the entire space between the top and bottom walls (20, 21) and integrally connected to both walls, accommodating screws passing through manifold ducts (2) and drawing these ducts in sealing relationship against the open ends of the hollow thermal collector body/ies (1).

38. Solar thermal collector according to claim 26, wherein the hollow thermal collector body/ies is/are fitted at their opposite ends in sealing relationship through planar side walls (33) or side wall portions of two feed, respectively withdrawal manifold ducts (2) and the manifold ducts hold the hollow thermal collector body/ies (1) freely suspended above the bottom wall of the collector box.

39. Solar thermal collector according to claim 38, wherein the feed and withdrawal manifold ducts (2) are in turn mounted between opposite side walls (13) of the collector box by the ends of the manifold ducts which are surrounded by insulating bushes (9) passing with a resilient press fit through holes in the side walls (13).

40. The solar collector as claimed in claim 26, wherein the thermal collector body or bodies (1) is/are hollow body/ies fitted at their opposite ends in sealing relationship to inlet and withdrawal ducts (2), wherein the inlet and withdrawal ducts, acting as manifold ducts (2) are provided by a continuously cast or extruded profile which at least along one longitudinal side is planar to provide a plane area for sealing engagement with a likewise planar end face of the hollow thermal collector body or bodies (1).

41. The solar collector as claimed in claim 40, wherein the inlet and withdrawal ducts have an external rectangular or square cross-section (29) and an end (39) of a duct (2) has been machined to form a connector member.

42. A process of manufacturing a solar thermal collector, more particularly having the features set out in claim 31, including the steps of producing by extrusion or continuous casting a reversible profile including a lateral outwardly directed flange (10) which, depending on which way around the profile is orientated, namely whether the collector is intended for mounting on a roof surface or the like or recessed into such surface, is provided proximate to either the lower edge (14, 17) or the upper edge (14, 17) of the side wall (13), two inwardly directed flanges (15, 16) respectively proximate to the lower and the upper edges (14, 17) for respectively having fitted thereto a bottom panel (5) and a cover panel (6), the latter for admitting solar radiation therethrough and for forming a barrier against the escape of thermal radiation from inside the box and further comprising, between the two inwardly directed flanges, a further inwardly directed flange (18) for positioning an insulation body provided between the bottom panel and such further flange, assembling side walls (13) of said profile with the lateral outwardly directed flange (10) proximate to what is to be the upper or lower edge (14, 17), depending on whether the collector is intended for mounting on a roof surface or the like or recessed into such surface, together with a bottom panel (5), covered by an insulation body rendered reflective on its upper side positioned between that inwardly directed flange (15, 16) which is proximate to what is to be the lower edge of the thermal collector and said further inwardly directed flange (18) to form a collector box of the solar thermal collector, and at an optional stage of such assembly installing inside the collector box one or more hollow solar thermal collector bodies containing a heat transfer medium flowing therethrough and, where applicable, closing the top of the collector box with a cover panel (6), allowing the entry of solar radiation into the box end forming a barrier against the escape of thermal radiation from inside the box, fitted onto the inwardly directed flange (15, 16) which is proximate the upper edge (14, 17).

43. The process according to claim 42, wherein the hollow thermal collector body or bodies (1) is/are hollow bodies fitted at their opposite ends in sealing relationship to inlet and withdrawal ducts (2), wherein the inlet and withdrawal ducts acting as manifold ducts (2) are provided by a continuously cast or extruded profile which at least along one longitudinal side is planar to provide a plane area for sealing engagement, with a likewise planar end face of the hollow thermal collector body or bodies (1) and wherein an end (39) of a duct (2) has been machined to a circular exterior cross-section to form a connector member.

44. The process as claimed in claim 42, wherein the one or more hollow thermal body/ies is/are integrally extruded or continuously cast to form hollow thermal panel body/ies including as an integral part of its/their cross-sectional profile a tubular hollow body adapted for the flow therethrough of a flowable heat carrier medium, and being an integrated extrusion or continuously cast profile in one piece having the cross-section of a flattish tube profile formed by a broad top wall (20) integrally connected on opposite sides to a similarly broad bottom wall (21), whereof at least the top wall (20) carries integrated surface enlarging outwardly directed heat transfer ribs (23) parallel to the tube axial direction (19) respectively the direction of extrusion or continuous casting and being set up for the said top wall (20) to be the side facing the sun so that the outwardly directed ribs (23) act as heat absorption and transfer ribs for absorbing solar radiation and transferring it as heat to the flowable heat carrier medium flowing through the tubular hollow body, connected for the inflow of cold heat carrier medium and for the withdrawal of the heated heat carrier medium.

45. A method of collecting thermal solar energy which includes using an integrally extruded or continuously cast hollow thermal collector body including as an integral part of its cross-sectional profile a tubular hollow body adapted for the flow therethrough of a flowable heat carrier medium, which is an integrated extrusion or continuously cast profile in one piece having the cross-section of a flattish tube profile formed by a broad top wall (20) connected on opposite sides to a similarly broad bottom wall (21), whereof at least the top wall (20) carries integrated surface enlarging outwardly directed heat transfer ribs (23) parallel to the tube axial direction (19) respectively the direction of extrusion or continuous casting, as a solar thermal collector body set up for the said top wall (20) to be the side facing the sun so that the outwardly directed ribs (23) act as heat absorption and transfer ribs for absorbing solar radiation and transferring it as heat to the flowable heat carrier medium flowing through the tubular hollow body connected for the inflow of cold heat carrier medium and for the withdrawal of the heated heat carrier medium.
